(19) United States
(12) Patent Application Publication
(10) Pub. No.: US 2006/0243397 A1
(43) Pub. Date: Nov. 2, 2006

(54) Cordless blind structure

(75) Inventor: Wen Ying Liang, Changhua Hsien (TW)

Correspondence Address: BIRCH STEWART KOLASCH & BIRCH, PO BOX 747, FALLS CHURCH, VA, 22040-0747, US

(73) Assignee: Ching Feng Home Fashions Co., Ltd.

(21) Appl. No.: 11/189,872

(22) Filed: Jul. 27, 2005

(30) Foreign Application Priority Data
Apr. 27, 2005 (TW) 094206608

(51) Int. Cl. E06B 9/06

(52) U.S. Cl. 160/84.06

(57) ABSTRACT

A cordless blind structure comprises a blind, and a plurality of control seats and guide tracks wherein the blind has a blind body fixedly attached to the underside of a headrail, a plurality of connecting elements, each having a guide block to be adapted to a guide groove of each guide track, fixed to both lateral side edges of the blind body, and a holding weight portion attached at the bottom edge thereof. The control seat, fixed above the holding weight portion thereon, has a set of crisscrossed positioning groove and pivoting groove appropriately defining therein for the accommodation of a switch element having a transverse T-shaped retaining block to be mounted into the guide groove of each guide track for sliding movement or abutting location therein, permitting the blind body to be stably collected or easily expanded without the use of any lift cords for achieving safer application thereby.

### BACKGROUND OF THE INVENTION

The present invention is related to a cordless blind structure, including a blind, and a plurality of control seats and guide tracks wherein the blind has a blind body fixedly attached to the underside of a headrail, a plurality of connecting elements each having a guide block equidistantly attached to both lateral side edges of the blind body, a holding weight portion attached at the bottom edge thereon, and the control seats symmetrically fixed at the bottom lateral edges above the holding weight portion; whereby, the control seats along with the connecting elements are cooperatively operated with the guide tracks thereof to stably collect or expand the blind body in a convenient and speedy manner without the use of any lift cords, efficiently achieving safer application thereby.

The conventional blind structure usually found on the market is made up of a roller gear set reciprocally operated with a lift cord set and a tape ladder set, which are tediously assembled in a rather time-consuming and painful manner. Besides, when the blind body thereof is raised in a collected state, the lift cord will suspend downwards and exposed outside for a certain length. And, children playing around can easily get caught in the dangling lift cord that, if the children are not released immediately there-from or when the lift cord is unlocked to withdraw upwards, can accidentally strangle and hurt the children caught therein. Thus, the conventional blind is quite unsafe in application thereof.

### SUMMARY OF THE PRESENT INVENTION

It is, therefore, the primary purpose of the present invention to provide a cordless blind structure, including a blind, a plurality of control seats, and a plurality of guide tracks wherein the blind has a blind body fixedly attached to the underside of a headrail, and the control seats along with guide blocks of connecting elements equidistantly attached at both lateral side edge of the blind body are cooperatively operated with the guide tracks thereof, permitting a retaining block protruding at one side of a switch element of each control seat to slide up or down at a guide groove of each guide track therein and abut against therewith for location so as to stably collect or expand the blind body in a convenient and speedy manner without the use of any lift cords, efficiently achieving safer application thereby.

It is, therefore, the second purpose of the present invention to provide a cordless blind structure wherein the switch element of each control seat is equipped with a switching portion capable of being bent upwards or downwards to actuate the retaining block switched into a vertical or a horizontal position at the guide groove of the guide track therein for the effects of sliding upwards/downwards movement therein or abutting location thereby respectively, achieving more convenient and flexible application thereof.

### BRIEF DESCRIPTION OF THE DRAWINGS

FIG. 1 is an exploded perspective view of the present invention.

FIG. 2 is a diagram showing an assembled perspective view of the present invention.

FIG. 3 is another diagram showing an assembled perspective view of the present invention.

FIG. 4 is an assembled perspective and partially enlarged view of the present invention.

FIG. 5 is an assembled cross sectional view of the present invention in application.

FIG. 6 is a partially enlarged and perspective view of a switch element of the present invention in a state of switching operation.

FIG. 7 is a diagram showing a blind body of the present invention located in a partially folded-up state.

FIG. 8 is a partially cross sectional view of a retaining block of the present invention in a state of abutting location thereof.

### DETAILED DESCRIPTION OF THE PREFERRED EMBODIMENTS

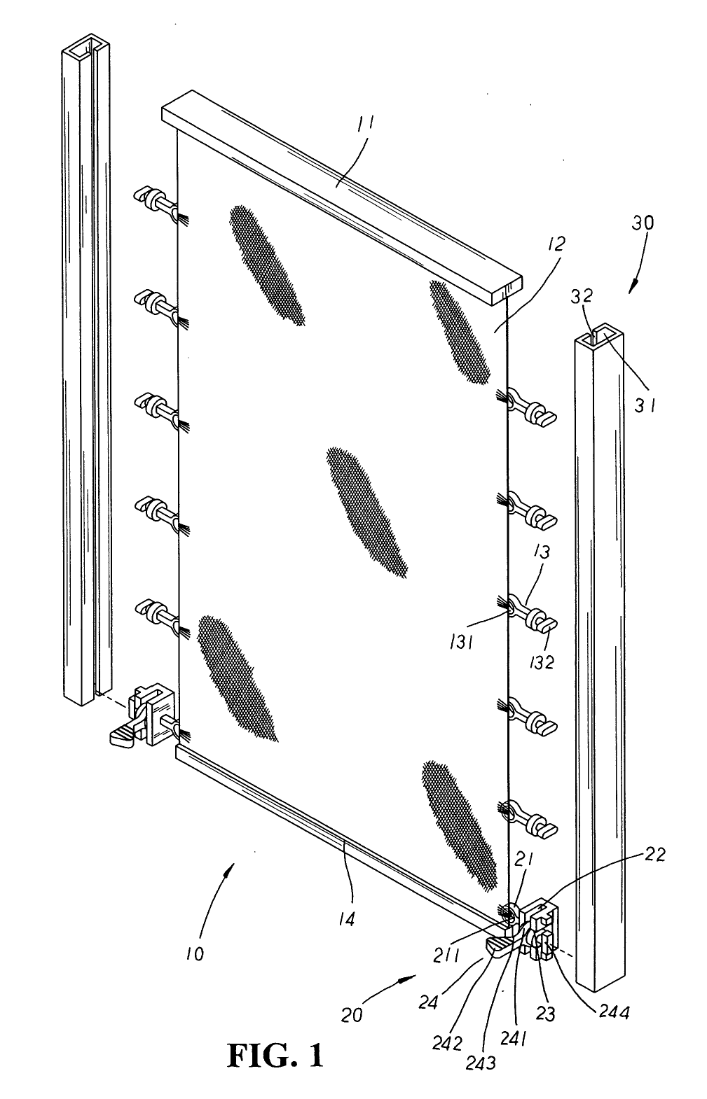

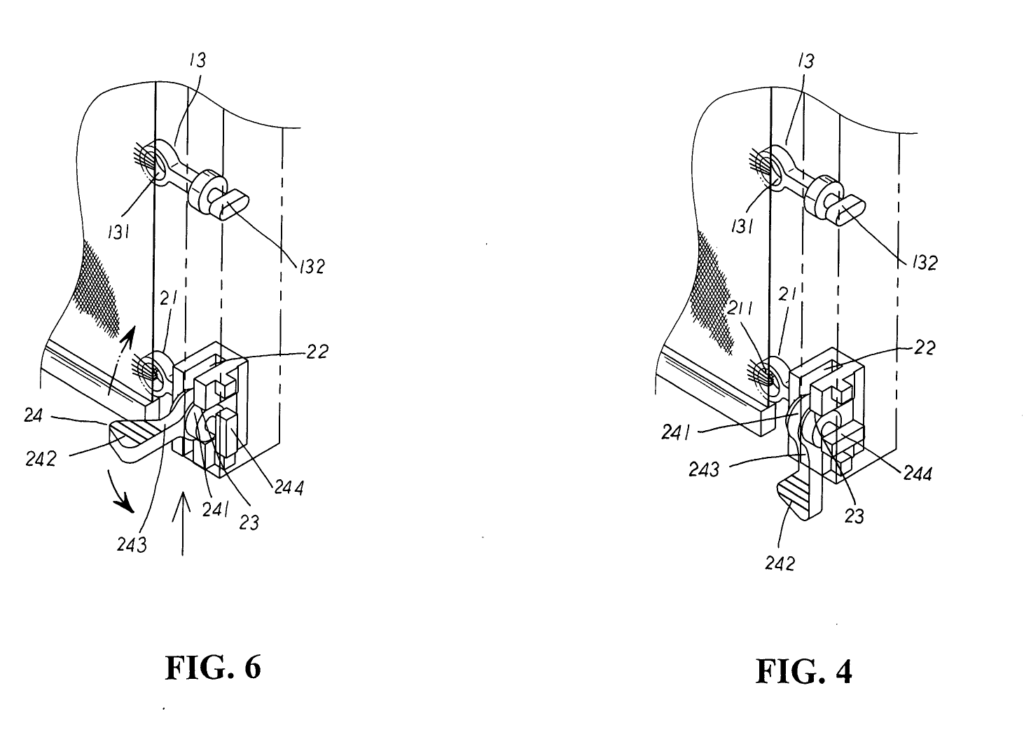

Please refer to FIG. 1 showing an exploded perspective view of the present invention. The present invention is related to a cordless blind structure, comprising a blind 10, a plurality of control seats 20, and a plurality of guide tracks 30. The blind 10 is made up of a blind body 12 fixedly attached to the underside of a headrail 11, and a plurality of connecting elements 13 that, each having a connecting hole 131 disposed at one side thereon and a guide block 132 protruding at the other side thereof, are equidistantly attached (preferably via sewing) to both lateral side edges of the blind body 12 thereon. The blind body 12 also has a holding weight portion 14 attached at the bottom edge thereon. The control seats 20 (referring also to FIG. 4) each having an engaging element 21 with an engaging hole 211 disposed thereon are symmetrically fixed (preferably via sewing) at both bottom lateral edges right above the holding weight portion 14 of the blind body 12 thereon. Inside the control seat 20 is appropriately disposed a positioning groove 22 and a pivoting groove 23 each communicating with the other in crosswise directions to form a crisscrossed configuration for the accommodation of a switch element 24 therein. The switch element 24 is made up of a three-staged pivoting portion 241 pivotally mounted to the bottom sidewall in the middle of the crisscrossed positioning groove 22 and the pivoting groove 23 thereof, a switching portion 242 extending at one end thereon, and a coupling section 243 correspondingly matched with the positioning groove 22 for accommodation therein. The switch element 24 also includes a transverse T-shaped retaining block 244 protruding at an appropriate position thereon. And each guide track 30 has a guide groove 31 and a passing space 32 mutually communicating in transverse T-shaped configuration and extending straight through the middle section of the guide track 30 to match with the guide blocks 132 of the connecting elements 13 and the retaining block 244 of the switch element 24 thereof for their accommodation therein.

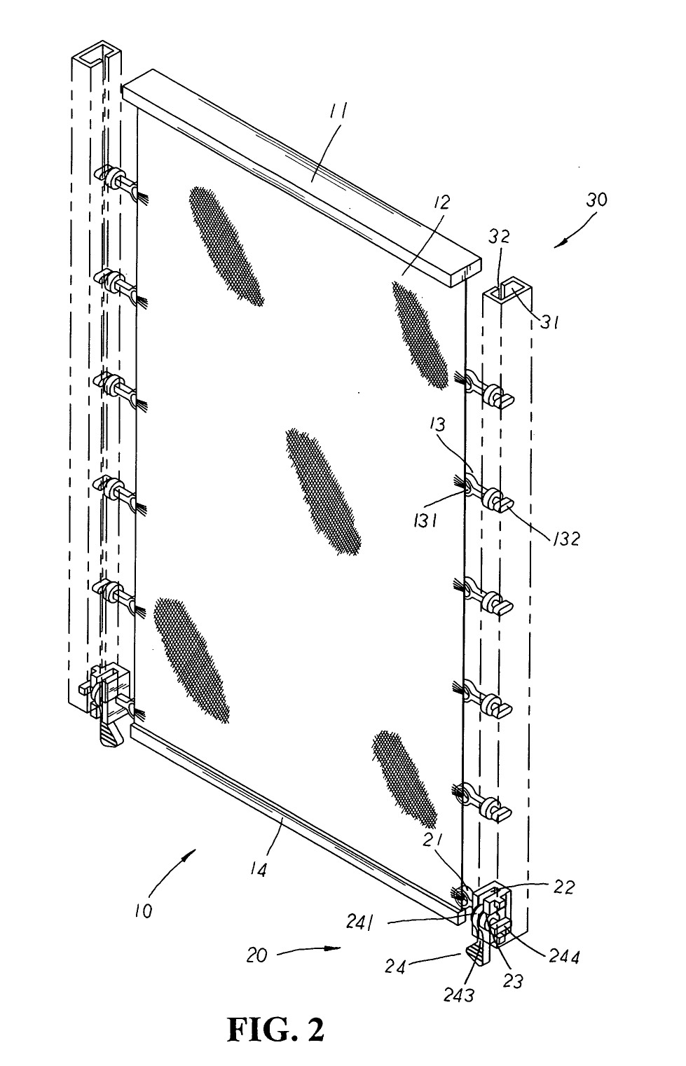

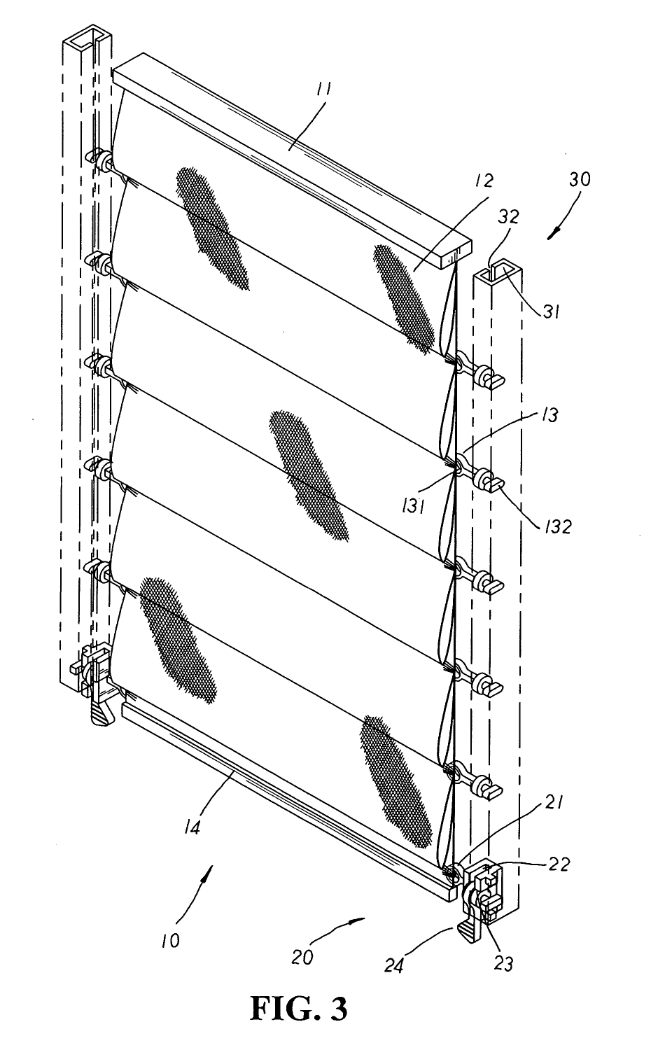

Please refer to FIGS. 2 to 3 inclusive. In assembly, the guide blocks 132 of the connecting elements 13 attached at both lateral side edges of the blind body 12 thereof and the retaining blocks 244 of the switch elements 24 thereof are sequentially led from top to bottom or vice versa to accommodate into the guide grooves 31 and the passing spaces 32 of the guide tracks 30 respectively (referring also to FIG. 4) to complete the assembly of the present invention.

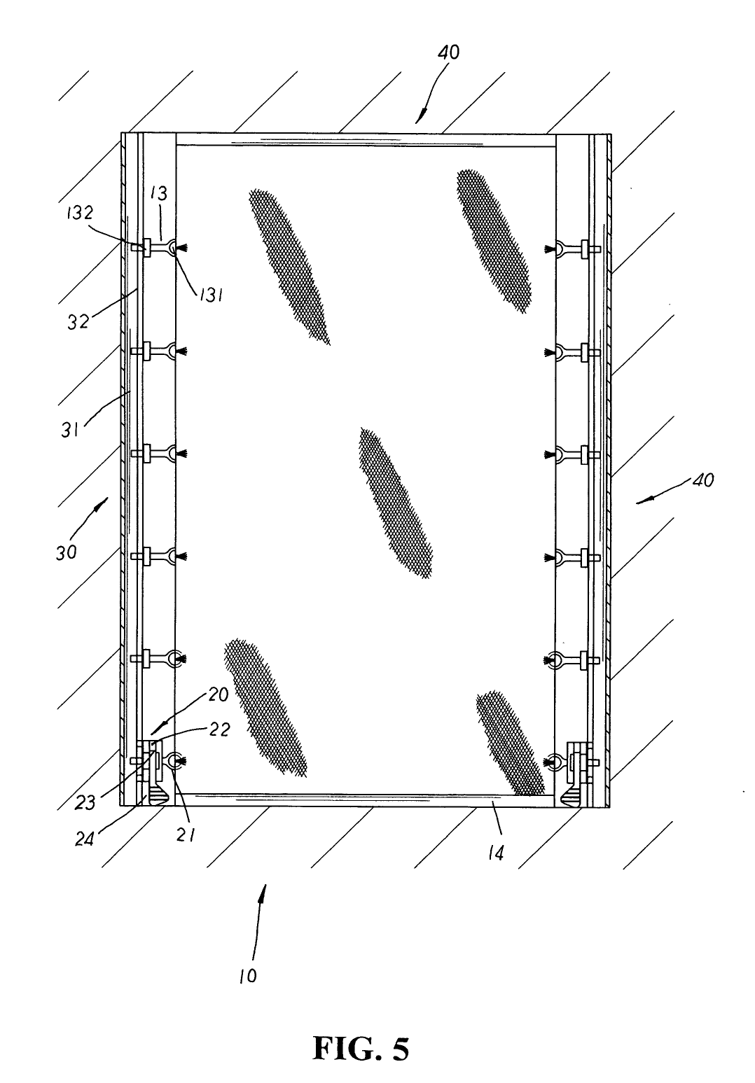

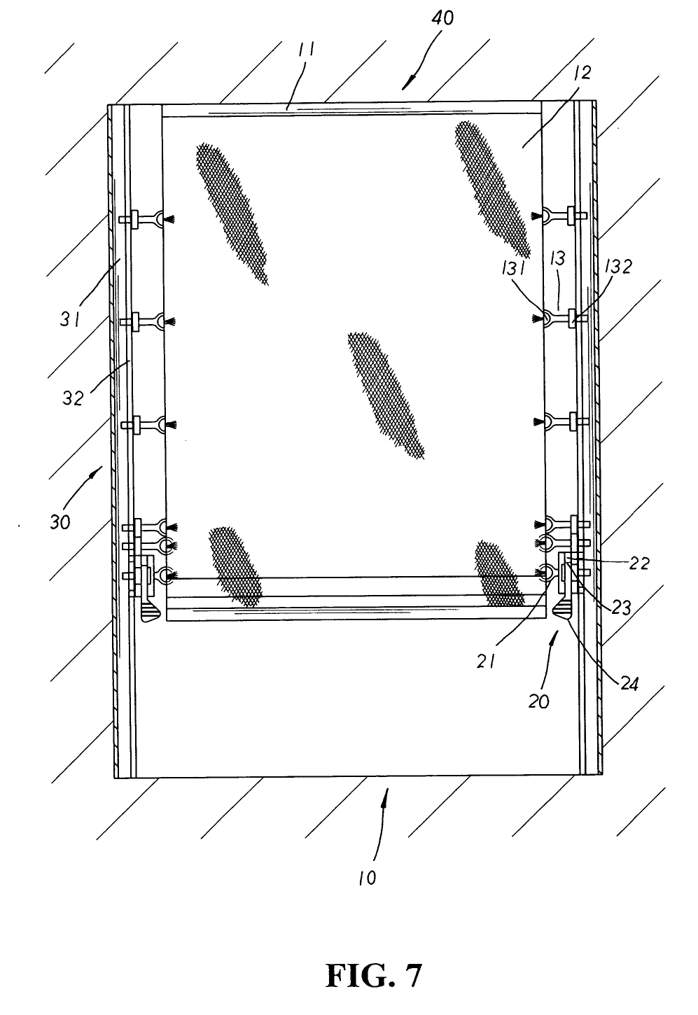

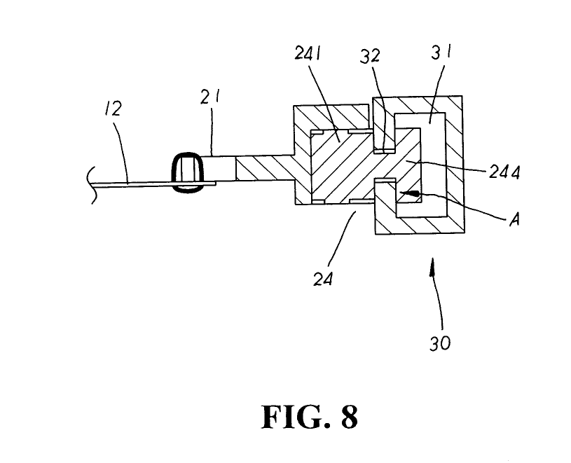

In application, the top edge of the headrail 11 of the blind 10 and one lateral side of both guide tracks 30 are respectively fixed to a conjoining surface 40 as shown in FIG. 5. To collect the blind body 12 upwards in an appropriately folded-up state, the control seat 20 is actuated via the switching portion 242 of the switch element 24 bent to one side, permitting the pivoting portion 241 thereof to rotate at the pivoting groove 23 therein and the coupling section 243 thereof to detach from the positioning groove 22 thereof. And the retaining block 244 of the switch element 24 can be synchronically brought into a vertical position as shown in FIG. 6 to slide smoothly along with the guide blocks 132 of the multiple connecting elements 13 upwards or downwards at the guide groove 31 and the passing space 32 of the guide track 30 therein. Meanwhile, the holding weight portion 14 can be pulled upwards to actuate the movement of the blind body 12 sequentially gathered upwards in folds till reaching a desired position as shown in FIG. 7. Then, the switch element 24 of the control seat 24 is bent towards the other side (either upwards or downwards as shown in FIG. 6), permitting the coupling section 243 thereof to accommodate into the positioning groove 22 and engage therewith. Meanwhile, the retaining block 244 of the switch element 24 is synchronically brought from the vertical position into a horizontal one as shown in FIG. 4 to contact with the inner surface of the guide groove 31 and form a plurality of abutting faces A therewith (referring to FIG. 8) for secure and tight abutting location thereby so as to hold the blind body 12 stably in a raised position without the risk of falling downwards there-from. And, to expand the blind body 12 downwards in an unfolded state thereof, the switching portion 242 of the switch element 24 is again bent to one side, permitting the pivoting portion 241 thereof to rotate at the pivoting groove 23 therein and the coupling section 243 thereof to detach from the position groove 22 thereof. Meanwhile, the holding weight portion 14 is drawn downwards to actuate the unfolding movement of the blind body 12 till an appropriate position. Then, the switch element 24 thereof is bent towards the other side (either upwards or downwards), permitting the coupling section 243 thereof to engage with the positioning groove 22, and the retaining block 244 thereof to horizontally contact with the inner surface of the guide groove 31 for abutting location thereby. Therefore, the blind 10 can be easily operated to collect or expand the blind body 12 in a convenient and speedy manner without the use of any lift cords to avoid the risk of strangling or hurting the children due to the exposed lift cords thereof, efficiently achieving safer application of the present invention thereof.

Moreover, the blind 10 of the present invention can be made into various types of blinds such as the Roman blind as shown in FIGS. 1, 2, or the hobbled Roman shade as shown in FIG. 3.

What is claimed is:

1. A cordless blind structure, comprising a blind, a plurality of control seats, and a plurality of guide tracks wherein at both lateral side edges of a blind body of the blind thereof are respectively fixed a plurality of connecting elements each having a guide block to be accommodated into a matched guide groove of each guide track for sliding movement therein, and at both bottom lateral edges of the blind body thereof is respectively attached one control seat having a movable switch element that, capable of switching up or down, is equipped with a retaining block to be mounted into the guide groove of the guide track for the effects of sliding upwards/downwards movement therein or abutting location thereby; therefore, the control seats along with the connecting elements thereof are cooperatively operated with the guide tracks to collect or expand the blind body of the blind in a convenient and speedy manner without the use of any lift cords mounted thereto, efficiently achieving safer application of the present invention thereof.

2. The cordless blind structure as claimed in claim 1 wherein the blind also includes a headrail with the blind body fixedly attached to its underside thereof, and a holding weight portion disposed at a predetermined position of the bottom edge thereon.

3. The cordless blind structure as claimed in claim 1 wherein each connecting element has a connecting hole disposed thereon.

4. The cordless blind structure as claimed in claim 1 wherein the multiple connecting elements can be symmetrically fixed in equal space at both lateral side edges of the blind body thereon.

5. The cordless blind structure as claimed in claim 1 wherein the control seats each having an engaging element with an engaging hole disposed thereon are symmetrically fixed at predetermined positions of the blind body thereon, and inside each control seat is appropriately disposed a positioning groove and a pivoting groove for the accommodation of a pivoting portion of the switch element having a switching portion and a coupling section disposed at the other side thereof.

6. The cordless blind structure as claimed in claim 1 wherein the retaining block of the switch element is made in a transverse T-shaped configuration.

7. The cordless blind structure as claimed in claim 1 wherein the guide groove of each guide track has a passing space defining thereon.

8. The cordless blind structure as claimed in claim 7 wherein the passing space of the guide track is communicated with the guide groove thereof to form a transverse T-shaped configuration thereby.

9. The cordless blind structure as claimed in claim 5 wherein the positioning groove and the pivoting groove defining the interior of each control seat are mutually communicated in crosswise directions to form a crisscrossed configuration thereby.

10. The cordless blind structure as claimed in claim 5 wherein the pivoting portion of the switch element is made in a three-staged form.
